(19) United States
(12) Patent Application Publication
(10) Pub. No.: US 2004/0207762 A1
(43) Pub. Date: Oct. 21, 2004

(54) Audio interrupt system for an automobile

(76) Inventor: Thomas Spinelli, East Northport, NY (US)

Correspondence Address: Thomas Spinelli, 2 Sipala Court, East Northport, NY, 11731, US

(21) Appl. No.: 10/407,629

(22) Filed: Apr. 4, 2003

(51) Int. Cl. H04N 7/18; H04N 5/268

(52) U.S. Cl. 348/705

(57) ABSTRACT

An interrupt system for an automobile including: at least one speaker for reproducing audio; a microphone operatively connected to the at least one speaker; and a switch for at least partially interrupting the reproduction of the audio at the at least one speaker and for reproducing an output of the microphone at the at least one speaker. Preferably, the audio is an audio portion of a video content from a video player having a display for displaying the video content. Furthermore, the at least one speaker is preferably a wireless headphones.

### BACKGROUND OF THE INVENTION

1. Field of the Invention

The present invention relates generally to automobiles, and more particularly, to an audio interrupt system for an automobile having a video player.

2. Prior Art

It is known in the art of automobiles to reproduce audio on speakers within the automobile. Recently, it is also known in the art of automobiles to reproduce video content on a display disposed in the automobile, such as from a DVD or VHS player, and to reproduce an audio portion of the video content on speakers within the automobile. More recently, audio from the automobile's radio, cassette player, or CD player, as well as the audio portion of the video content can be reproduced on wireless headphones. The wireless headphones are typically worn by passengers in the car, other than the driver. This allows the driver to listen to other audio from another source, such as from the radio, cassette, or CD player, while the passengers listen to the audio portion of the video content, or to not listen to any audio at all. Although, not popular at this time, the video content can also be from a broadcast, such as a radio frequency or satellite broadcast.

Although, the wireless headphones have their advantages, those wearing them cannot hear instructions from the driver or other passenger who is not wearing the headphones. The instructions could simply be an alerting of a tourist attraction (e.g., “hey kids, look at the cows grazing on the left”), or instructions to the passengers to turn off the video content or the headphones because the destination of the vehicle has been or is about to be reached (e.g., “we are almost there, please turn off your headphones and pass them to the front”). However, the instructions can also relate to an emergency. In such situations it is imperative for the passengers wearing the headphones to hear the instructions and take the necessary precautions.

### SUMMARY OF THE INVENTION

Therefore it is an object of the present invention to provide an audio interrupt system for an automobile that overcomes the disadvantages of the prior art.

Accordingly, an interrupt system for an automobile is provided. The interrupt system comprises: a video player having a display for displaying video content; at least one speaker for reproducing an audio portion of the video content; a microphone operatively connected to the at least one speaker; and a switch for at least partially interrupting the reproduction of the audio portion at the at least one speaker and for reproducing an output of the microphone at the at least one speaker.

The video player is preferably one of a DVD player and a VHS player.

Preferably, the at least one speaker is a wireless headphones operatively connected to the video player.

The switch is preferably disposed in a steering wheel in the automobile. Alternatively, the switch is disposed in a dashboard of the automobile.

Also provided is an interrupt system for an automobile, where the interrupt system comprises: a display for displaying video content from a player; at least one speaker for reproducing an audio portion of the video content; a microphone operatively connected to the at least one speaker; and means for at least partially interrupting the reproduction of the audio portion at the at least one speaker and for reproducing an output of the microphone at the at least one speaker.

Preferably, the at least one speaker is a wireless headphones operatively connected to the player.

Preferably, the means is a switch disposed in a steering wheel in the automobile. Alternatively, the means is a switch disposed in a dashboard of the automobile.

Still provided is an automobile comprising: a video player for playing a video content; a display for displaying the video content to at least one passenger in the automobile; at least one speaker for reproducing an audio portion of the video content; a microphone operatively connected to the at least one speaker; and a switch for at least partially interrupting the reproduction of the audio portion at the at least one speaker and for reproducing an output of the microphone at the at least one speaker.

The video player is one of a DVD player and a VHS player.

Preferably, the at least one speaker is a wireless headphones operatively connected to the video player and worn by the at least one passenger.

The switch is preferably disposed in a steering wheel of the automobile. Alternatively, the switch is disposed in a dashboard of the automobile.

Still provided is an automobile comprising: a video player for playing a video content; a display for displaying the video content to at least one passenger in the automobile; at least one speaker for reproducing an audio portion of the video content; a microphone operatively connected to the at least one speaker; and means for at least partially interrupting the reproduction of the audio portion at the at least one speaker and for reproducing an output of the microphone at the at least one speaker.

Preferably, the video player is one of a DVD player and a VHS player.

The at least one speaker is preferably a wireless headphones operatively connected to the video player and worn by the at least one passenger.

Preferably, the means is a switch disposed in a steering wheel of the automobile. Alternatively, the means is a switch disposed in a dashboard of the automobile.

Still provided is a method for interrupting an audio portion of video content in an automobile. The method comprising: displaying the video content on a display in the automobile; reproducing an audio portion of the video content on at least one speaker in the automobile; at least partially interrupting the audio portion of the video content from being reproduced on the at least one speaker; and during the interrupting, reproducing the output of a microphone located in the automobile on the at least one speaker.

Preferably, the at least one speaker is a wireless headphones and the reproducing of the audio portion and output of the microphone comprises wirelessly transmitting the audio portion and the output of the microphone to the wireless headphones.

Still provided is an interrupt system for an automobile, where the interrupt system comprises: at least one speaker for reproducing audio; a microphone operatively connected to the at least one speaker; and a switch for at least partially interrupting the reproduction of the audio at the at least one speaker and for reproducing an output of the microphone at the at least one speaker.

The interrupt system preferably further comprises a video player having a display for displaying a video content on the display, the video player being operatively connected to the at least one speaker, wherein the audio is an audio portion of the video content.

Preferably, the at least one speaker is a wireless headphones operatively connected to the video player.

Still provided is an interrupt system for an automobile, wherein the interrupt system comprises: at least one speaker for reproducing audio; a microphone operatively connected to the at least one speaker; and means for at least partially interrupting the reproduction of the audio at the at least one speaker and for reproducing an output of the microphone at the at least one speaker.

The interrupt system preferably further comprises a video player having a display for displaying a video content on the display, the video player being operatively connected to the at least one speaker, wherein the audio is an audio portion of the video content.

Preferably, the at least one speaker is a wireless headphones operatively connected to the video player.

Still provided is a method for interrupting an audio portion of video content in an automobile. The method comprising: reproducing audio on at least one speaker in the automobile; at least partially interrupting the audio from being reproduced on the at least one speaker; and during the interrupting, reproducing the output of a microphone located in the automobile on the at least one speaker.

The method preferably further comprises displaying video content on a display in the automobile, wherein the audio is an audio portion of the video content and the reproducing of the audio portion and output of the microphone comprises wirelessly transmitting the audio portion and the output of the microphone to the wireless headphones.

Still yet provided is a headphones comprising: at least one speaker for reproducing audio thereon; a microphone operatively connected to at least one other speaker remote from the headphones; and a first switch for at least partially interrupting the reproduction of the audio portion at the at least one other speaker and for reproducing an output of the microphone at the at least one other speaker. The headphones preferably further comprises a second switch for terminating an interruption capability at the at least one speaker from another microphone remote from the headphone.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a schematic top view of an automobile having a video player having a preferred implementation of an interrupt system of the present invention.

FIG. 2 illustrates a schematic circuit diagram of the interrupt system of FIG. 1.

FIG. 3 illustrates an alternative headphone for use with the interrupt system of the present invention.

### DETAILED DESCRIPTION OF THE PREFERRED EMBODIMENT

Although this invention is applicable to numerous and various types of audio, it has been found particularly useful in the environment of an audio portion of video content reproduced within an automobile. Therefore, without limiting the applicability of the invention to an audio portion of video content reproduced within an automobile, the invention will be described in such environment.

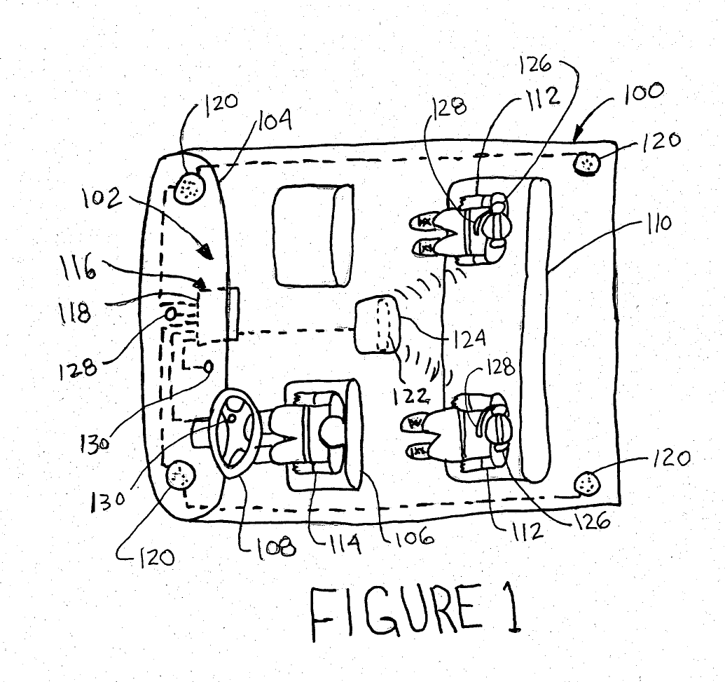

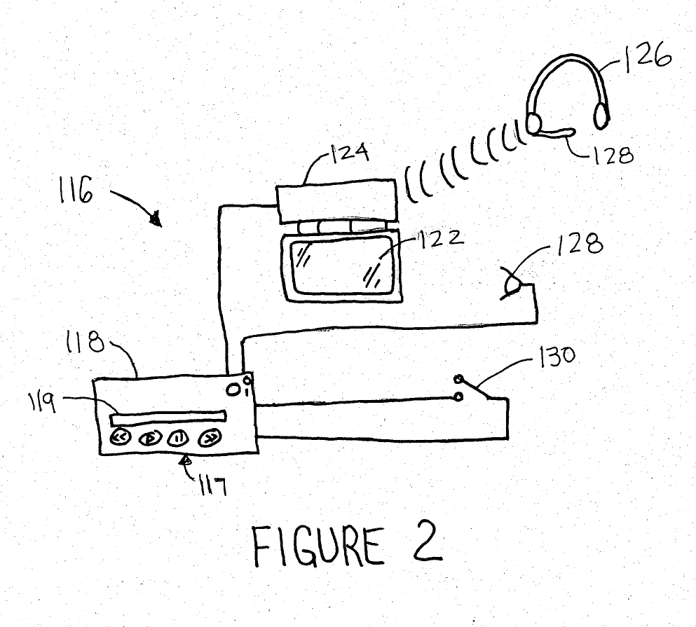

Referring now to FIGS. 1 and 2, an interrupt system for an automobile is shown therein, the automobile being referred to by reference numeral 100 and the interrupt system being generally referred to by reference numeral 102. The automobile 102 is shown schematically having a dashboard 104, a driver's seat 106, a steering wheel 108 within reach of the driver, and one or more passenger seats 110. The passenger is referred to generally by reference numeral 112, while the driver is referred to generally by reference numeral 114. The interrupt system 102 of the present invention can be used with either audio from a CD player, cassette player, or radio (hereinafter “radio/cassette/CD player”) within the automobile 100 or with a video player system 116. Such video player systems 116 for automobiles, particularly minivans and Suvs, are well known in the art and typically comprise a VHS or DVD player console 118 which is operatively connected to speakers 120 and a display 122. However, such video players may also include a tuner for receiving RF or satellite transmissions and displaying video content from the transmission on the display 122. The player console 118 is typically in or near the dashboard 104 for operation by the driver 114 or other front seat passenger (not shown) and contains a bay 119 for insertion of a DVD or VHS tape and one or more buttons 117 for operation of the player 118. The display 122 is typically mounted in a console 124 on the interior ceiling of the automobile 100 and facing towards the rear passengers 112. The display may also have buttons for operation of the player 118. However, the display 122 may also be configured in other ways known in the art, such as in a console between the front seats 106, in the back of a seat, or even in the dashboard for use by a front seat passenger. As discussed above, video player systems 116 for automobiles 100 also use headphones 126 as speakers to reproduce audio from the radio/cassette/CD players or to reproduce a video portion of a video content played on the video player 116. Such headphones 126 typically receive a wireless transmission from the video player system 116 (e.g., either from the player console 116 or from the display console 124). Wireless transmission between such video player systems 116 and wireless headphones 126 in automobiles is well known in the art. Therefore, the video player system 116 and headphones 126 are assumed to have the components necessary to carry out such wireless operation.

The present invention provides an interrupt system as part of the radio/cassette/CD player in the automobile and/or the video player system 116. The interrupt system preferably includes a microphone 128 operatively connected to the speakers 120 and/or wireless headphones 126. The microphone 128 is preferably disposed in a central portion of the dashboard to pick up the voices of either the driver 114 or a front seat passenger (not shown). The interrupt system further preferably includes a switch 130 for at least partially interrupting the reproduction of the audio from the radio/cassette/CD player and/or the audio portion of the video content from the video player 116 at the speaker 120 and/or at the headphones 126. Operation of the switch 130 (or alternatively operation of another switch) also reproduces an output of the microphone 128 at the speakers 120 and/or at the wireless headphones 126. The switch 130 is preferably disposed on a front surface of the steering wheel 108 for easy operation by the driver 114. However, the switch 130 may, in addition to, or instead of, be disposed in the dashboard 104 at a convenient position for operation by either the driver 114 or a front seat passenger (not shown). Alternatively, the front seat passenger may be supplied with his/her own switch 130 positioned in the dashboard 104 or other conveniently located position. Preferably, the switch 130 is a simple push button switch that when depressed actuates the interrupt system capabilities (e.g., allows the driver 114 or front seat passenger to interrupt the audio or audio portion of video content to speak with the rear seat passengers 112 through the speakers 120 and/or through the wireless headphones 126 worn by the rear seat passengers 112). Releasing the switch 130 would then resume normal operation of the audio or audio portion of the video content through the speakers 120 and/or wireless headphones 126. The switch 130 may be of any other type or configuration known in the art. For example, the interrupt system may be activated with the push or flip of the switch 130 and normal operation resumed with another push or flip of the switch 130 or a different switch.

As discussed above, operation of the switch 130 interrupts the audio from the radio/cassette/CD player or the audio portion of video content from the video player system 116 to the speakers 120 and/or wireless headphones 126. While the audio or audio portion is being interrupted, the driver 114 and/or other front seat passenger can speak to the other passengers 112 by way of the microphone 128 through the speakers 120 and/or wireless headphones 126. In the case where the display 122 is provided for the font seat passenger, the interrupt system allows the driver to speak to the font seat passenger, for example, when the front seat passenger is wearing headphones. Although it is preferred for the audio or audio portion to be completely interrupted, i.e., muted, it may also be lowered in volume such that the voice of the driver 114 and/or other front seat passenger can be heard over the audio or audio portion.

Thus, those skilled in the art will appreciate that the interrupt systems of the present invention provide a necessary means to communicate with passengers who are preoccupied by listening to music or audio from a movie or other broadcast, particularly while those passengers are wearing wireless headphones. The interrupt systems of the present invention allow the driver or other front seat passenger to provide directions to the other passengers, where the directions may be informal or relating to an emergency.

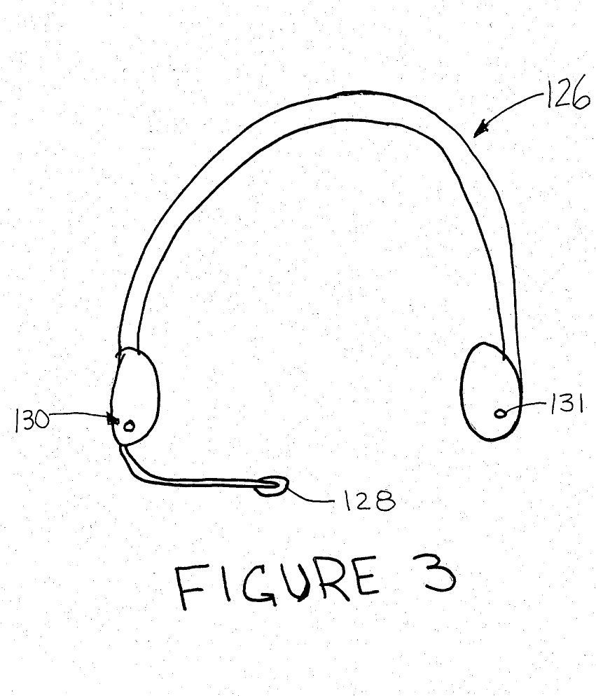

Those skilled in the art will also appreciate that while the interrupt systems of the present invention have been described with regard to the driver or other front seat passenger speaking to other passengers by way of the microphone, the interrupt systems are not limited thereto. For example, each rear seat passenger 112 may be provided with a switch and/or microphone for speaking with each other. For example, as shown in FIG. 3, such switch 130 and microphone 128 may be provided on each passenger's headphones 126. In such a configuration, the headphones 126 would preferably have both a wireless receiver and transmitter for receiving wireless signals from the radio/cassette/CD player, from the video player system 116, and from other microphones and for transmitting wireless signals from the microphone 128 to the other similarly equipped headphones 126 (or other speakers 120). Alternatively, each passenger's switch 130 and microphone 128 may be provided proximate to their seated position, such as in a door panel near each passenger 112.

In this manner, each of the passengers 112 can communicate with another passenger through the interrupt system. Furthermore, each passenger 112 may also have a means, such as another switch 131, to turn off the interrupt system, particularly from other passengers. However, it is preferred that operation of the interrupt system from the driver 114 or other front seat passenger not be capable of being overridden or otherwise shut off. While the interrupt system is turned off, when another passenger is trying to communicate with the passenger, the passenger's headphones can reproduce a beep or other means for alerting the passenger that another passenger is trying to communicate with him/her, such as a flashing light. The passenger can then decide whether to operate the other switch 131 to enable the interrupt system.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. An interrupt system for an automobile, the interrupt system comprising:
a video player having a display for displaying video content;
at least one speaker for reproducing an audio portion of the video content;
a microphone operatively connected to the at least one speaker; and
a switch for at least partially interrupting the reproduction of the audio portion at the at least one speaker and for reproducing an output of the microphone at the at least one speaker.

2. The interrupt system of claim 1, wherein the video player is a DVD player.

3. The interrupt system of claim 1, wherein the video player is a VHS player.

4. The interrupt system of claim 1, wherein the at least one speaker is a wireless headphones operatively connected to the video player.

5. The interrupt system of claim 1, wherein the switch is disposed in a steering wheel in the automobile.

6. The interrupt system of claim 1, wherein the switch is disposed in a dashboard of the automobile.

7. An interrupt system for an automobile, the interrupt system comprising:
a display for displaying video content from a player;
at least one speaker for reproducing an audio portion of the video content;
a microphone operatively connected to the at least one speaker; and
means for at least partially interrupting the reproduction of the audio portion at the at least one speaker and for reproducing an output of the microphone at the at least one speaker.

8. The interrupt system of claim 7, wherein the at least one speaker is a wireless headphones operatively connected to the player.

9. The interrupt system of claim 7, wherein the means is a switch disposed in a steering wheel in the automobile.

10. The interrupt system of claim 7, wherein the means is a switch disposed in a dashboard of the automobile.

11. An automobile comprising:
a video player for playing a video content;
a display for displaying the video content to at least one passenger in the automobile;
at least one speaker for reproducing an audio portion of the video content;
a microphone operatively connected to the at least one speaker; and
a switch for at least partially interrupting the reproduction of the audio portion at the at least one speaker and for reproducing an output of the microphone at the at least one speaker.

12. The automobile of claim 11, wherein the video player is a DVD player.

13. The automobile of claim 11, wherein the video player is a VHS player.

14. The automobile of claim 11, wherein the at least one speaker is a wireless headphones operatively connected to the video player and worn by the at least one passenger.

15. The automobile of claim 11, wherein the switch is disposed in a steering wheel of the automobile.

16. The automobile of claim 11, wherein the switch is disposed in a dashboard of the automobile.

17. An automobile comprising:
a video player for playing a video content;
a display for displaying the video content to at least one passenger in the automobile;
at least one speaker for reproducing an audio portion of the video content;
a microphone operatively connected to the at least one speaker; and
means for at least partially interrupting the reproduction of the audio portion at the at least one speaker and for reproducing an output of the microphone at the at least one speaker.

18. The automobile of claim 17, wherein the video player is a DVD player.

19. The automobile of claim 17, wherein the video player is a VHS player.

20. The automobile of claim 17, wherein the at least one speaker is a wireless headphones operatively connected to the video player and worn by the at least one passenger.

21. The automobile of claim 17, wherein the means is a switch disposed in a steering wheel of the automobile.

22. The automobile of claim 17, wherein the means is a switch disposed in a dashboard of the automobile.

23. A method for interrupting an audio portion of video content in an automobile, the method comprising:
displaying the video content on a display in the automobile;
reproducing an audio portion of the video content on at least one speaker in the automobile;
at least partially interrupting the audio portion of the video content from being reproduced on the at least one speaker; and
during the interrupting, reproducing the output of a microphone located in the automobile on the at least one speaker.

24. The method of claim 23, wherein the at least one speaker is a wireless headphones and the reproducing of the audio portion and output of the microphone comprises wirelessly transmitting the audio portion and the output of the microphone to the wireless headphones.

25. An interrupt system for an automobile, the interrupt system comprising:
at least one speaker for reproducing audio;
a microphone operatively connected to the at least one speaker; and
a switch for at least partially interrupting the reproduction of the audio at the at least one speaker and for reproducing an output of the microphone at the at least one speaker.

26. The interrupt system of claim 25, further comprising a video player having a display for displaying a video content on the display, the video player being operatively connected to the at least one speaker, wherein the audio is an audio portion of the video content.

27. The interrupt system of claim 26, wherein the at least one speaker is a wireless headphones operatively connected to the video player.

28. An interrupt system for an automobile, the interrupt system comprising:
at least one speaker for reproducing audio;
a microphone operatively connected to the at least one speaker; and
means for at least partially interrupting the reproduction of the audio at the at least one speaker and for reproducing an output of the microphone at the at least one speaker.

29. The interrupt system of claim 28, further comprising a video player having a display for displaying a video content on the display, the video player being operatively connected to the at least one speaker, wherein the audio is an audio portion of the video content.

30. The interrupt system of claim 29, wherein the at least one speaker is a wireless headphones operatively connected to the video player.

31. A method for interrupting an audio portion of video content in an automobile, the method comprising:
reproducing audio on at least one speaker in the automobile;
at least partially interrupting the audio from being reproduced on the at least one speaker; and
during the interrupting, reproducing the output of a microphone located in the automobile on the at least one speaker.

32. The method of claim 31, further comprising displaying video content on a display in the automobile, wherein the audio is an audio portion of the video content and the reproducing of the audio portion and output of the microphone comprises wirelessly transmitting the audio portion and the output of the microphone to the wireless headphones.

33. A headphone comprising:
at least one speaker for reproducing audio thereon;
a microphone operatively connected to at least one other speaker remote from the headphones; and
a first switch for at least partially interrupting the reproduction of the audio portion at the at least one other speaker and for reproducing an output of the microphone at the at least one other speaker.

34. The headphone of claim 33, further comprising a second switch for terminating an interruption capability at the at least one speaker from another microphone remote from the headphone.
